(19) United States
(12) Patent Application Publication
(10) Pub. No.: US 2017/0000586 A1
(43) Pub. Date: Jan. 5, 2017

(54) Bite Block Lip Protector

(71) Applicant: Robyn Lesser, Clearwater, FL (US)

(72) Inventor: Robyn Lesser, Clearwater, FL (US)

(21) Appl. No.: 14/790,374

(22) Filed: Jul. 2, 2015

(51) Int. Cl. A61C 5/14

(52) U.S. Cl. CPC A61C 5/14

(57) ABSTRACT

This invention comprises a lip protector made of a pliable, bio-compatible material for holding a patient's lips out of the way during a dental procedure, the lip protector comprising an upper and lower lip guard, each lip guard flared away from facial features, each lip guard comprising a lip guard groove for receiving the dental patient's lip; a lip guard rim; and a flared lip guard end, wherein the upper and lower flared lip guard ends are each flared in substantially the same direction; a substantially annular perimeter wherein the substantially annular perimeter connects the upper lip guard and the lower lip guard so that, when placed in the dental patient's mouth, the upper lip guard receives the patient's upper lip and the lower lip guard receives the patient's lower lip; an intraoral mouthpiece comprising: a tube; a tongue retractor capable of maneuvering and holding the dental patient's tongue out of the way during the dental procedure; and a bite guard comprising upper and lower bite grooves; and a tube clip interconnected with the substantially annular perimeter such that the tube clip does not interfere with the upper and lower lip guards, the tube clip configured to receive the intraoral mouthpiece.

### BACKGROUND OF THE INVENTION

Field of the Invention

The present invention relates to a bite bock lip protector. More particularly, the present invention relates to a bite block lip protector designed to keep a patient's lips out of the way while work is being done by a dental professional.

Description of the Background Art

When a dental professional is working with a patient, it is important that there be nothing in the way so that the dental professional can see what they are working on. Without a clear sightline into the patient's mouth, the dentist or dental surgeon could accidently jab the patient with a drill or some other tool that would cause pain to the patient. The primary part of a patient's mouth that can get in the way are the lips and cheeks. Many of the tools currently used when working on patients result in the patient's lips staying in the way of the dental professional's sight lines.

Presently, there exists a need for a device that can be attached to other tools used by dental professionals that would allow for the dental professional to keep the patient's lips out of the way while working on the patient and still maintain the patient's comfort. Other designs have been put forth but each lack the simplicity, usefulness, comfort, and connection capabilities available in the present invention.

For example, U.S. Pat. No. 4,592,344 to Scheer describes a combination illuminator and lip and cheek expander. Scheer features a pair of expanders that go on each side of the mouth which are separate and apart from one another. While this keeps the patient's mouth open, Scheer does nothing to keep the patient's lips out of the way when working on the front incisors or canines or from blocking any view when working on molars. Nor does Scheer allow for the use of other dental equipment that may interact with the lips or cheeks, due to the expanders already occupying that space. The present invention is a single unit which can attach to other devices so that the dental professional can do their work and moves the patient's lips out of the way.

U.S. Pat. No. 5,037,298 to Hickham describes an apparatus and process for removing saliva while retracting cheeks and lips. Hickham uses a pair of uncomfortable cheek and lip refractors that come apart in the middle. Hickham does not describe a continuous cheek and lip refractor but instead uses a spring loaded resilient member to hold the cheek and lip retractor apart during its operation. Nor does Hickham allow for the connection of other dental equipment to its apparatus. The present invention is a single continuous piece of material which allows for other devices to attach to it so that multiple pieces of equipment can perform while, at the same time, comfortably retracting the patient's lips and cheeks.

Therefore, it is an object of this invention to provide an improvement which overcomes the aforementioned inadequacies of the prior art devices and methods and provides and improvement which is a significant contribution to the advancement of the lip protector art.

Another object of this invention is to provide a bite block lip protector for use in medical settings that allow a dental professional to have access to a patient's mouth without having the patient's lips block access or view by comfortably moving the patient's lips into an offset position.

Another object of this invention is to provide a simple, useful, comfortable, and connectable lip protector for use in dental examinations, surgery, or any other procedures.

Another object of this invention is to provide an ergonomic lip protector that can be used with a multitude of other dental equipment.

The foregoing has outline some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a lip protector made of a pliable, bio-compatible material for holding a patient's lips out of the way during a dental procedure, the lip protector comprising an upper and lower lip guard, each lip guard flared away from facial features, each lip guard comprising a lip guard groove for receiving the dental patient's lip; a lip guard rim; and a flared lip guard end, wherein the upper and lower flared lip guard ends are each flared in substantially the same direction; a substantially annular perimeter wherein the substantially annular perimeter connects the upper lip guard and the lower lip guard so that, when placed in the dental patient's mouth, the upper lip guard receives the patient's upper lip and the lower lip guard receives the patient's lower lip; an intraoral mouthpiece comprising: a tube; a tongue retractor capable of maneuvering and holding the dental patient's tongue out of the way during the dental procedure; and a bite guard comprising upper and lower bite grooves; and a tube clip interconnected with the substantially annular perimeter such that the tube clip does not interfere with the upper and lower lip guards, the tube clip configured to receive the intraoral mouthpiece.

When reference is made to something being “flared,” it is meant that the material being described is generally angled in one direction. If an element that is described as “flared” has multiple parts, for example, the upper and lower lip guards, then both parts are preferably angled in the same direction. This means that if the upper lip guard is flared away from the patient's face then the lower lip guard would also be flared away from the patient's face.

A “groove” generally means the dictionary definition of groove, i.e., a long, narrow cut or indentation in a surface, however, the lip guard grooves described herein are preferably only as narrow as the average human lip. Any narrower would cause discomfort for the patient.

When reference is made to the patient's lips being “offset,” it is meant that the patient's lips are displaced from their resting position and kept in that position while the dental professional performs a procedure. This can mean that only the upper lip is displaced or only the lower lip is displaced or both are displaced at the same time.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designed other structures and methods for carrying out the same purposed of the present invention. It should also be realized by those skilled in the art that such equivalent constructions and methods do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the lip protector in use in combination with dental equipment.

FIG. 2 is a cross-sectional view of a patient's mouth while the lip protector is in use.

FIG. 3 is a perspective view of the lip protector connected to a type of dental equipment.

FIG. 4 is a front perspective view of the lip protector.

FIG. 5 is a top perspective view of the lip protector.

### DETAILED DESCRIPTION OF THE PREFERRED EMBODIMENT

The following description is of a preferred embodiment presently contemplated for carrying out the invention. This description is not to be taken in a limiting sense, but is made merely for the purpose of describing one or more preferred embodiments of the invention. The scope of the invention should be determined with reference to the claims.

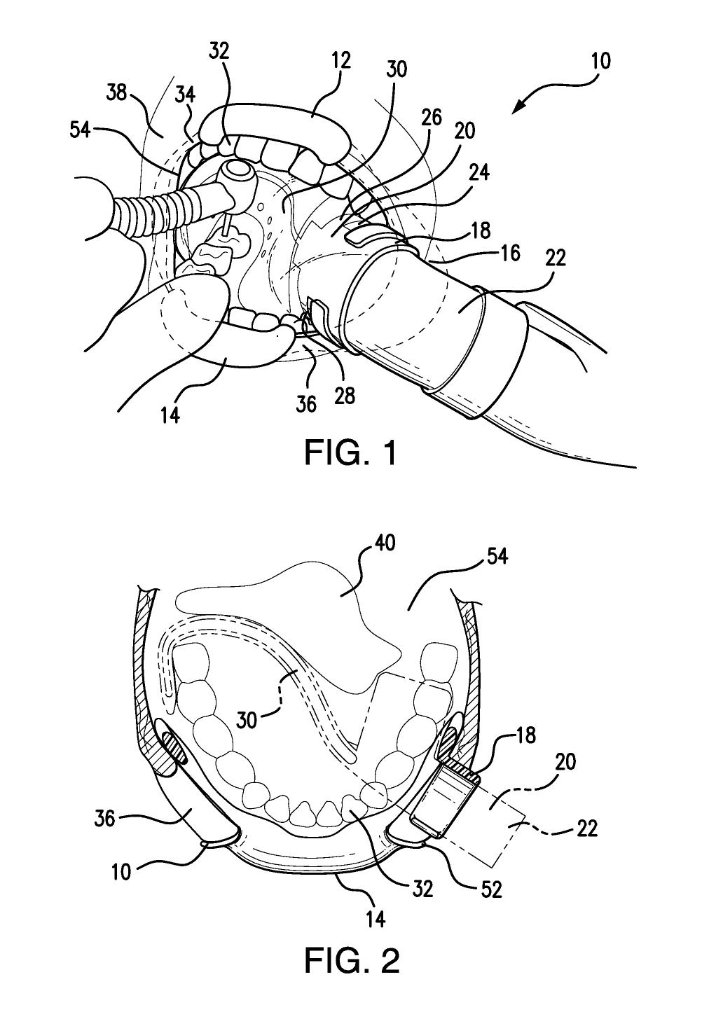

The present invention is illustrated in FIG. 1. In this preferred embodiment, the lip protector 10 comprises an upper lip guard 12 and a lower lip guard 14 and a perimeter 16. As can be seen in the figure, the perimeter 16 has a tube clip 18 attached it. The position of the tube clip 18 can depend on the handedness of the dentist and the side of the mouth 54 on which the dental professional is performing a procedure. As the lip protector 10 is symmetrical, it can be flipped 180 degrees and still adequately perform its function. In the preferred embodiment, the lip protector 10 attaches to a type of intraoral mouthpiece 20 which generally comprises a tube 22, a bite guard 24 comprising an upper bite guard 26 and lower bite guard 28, and a tongue retractor 30. Using the lip protector 10 in combination with this particular piece of intraoral mouthpiece 20 exposes the teeth 32 by forcing the upper lip 34 and the lower lip 36 out of the way. The perimeter 16 extends longitudinally such that the patient's cheeks 38 are protected while the dental professional performs the dental procedure. When the lip protector 10 is used with the intraoral mouthpiece 20 the patient is forced to keep their mouth 54 open due to the tube 22, upper bite guard 26, and lower bite guard 28 being thicker and/or less malleable than the other portions of the intraoral mouthpiece 20. The lip protector 10 is malleable enough to allow the patient's upper lip 34 and lower lip 36 to be placed in the upper lip guard 12 and the lower lip guard 14 respectively.

Preferably, the lip protector 10 is one piece, flexible, and the body is made of a single homogeneous material that is injection molded. Preferably, the lip protector 10 is disposable. When in use, the dental professional attaches the lip protector 10 to another piece of intraoral mouthpiece 20 which, in a preferred embodiment, is the intraoral device described in U.S. Pat. No. 7,748,981. It is contemplated that the present invention can be used with other dental equipment and is not limited to the intraoral device described herein. The intraoral 20 attaches to the lip protector 10 using the tube clip 18. Once attached, the combination lip protector 10/intraoral mouthpiece 20 is inserted into the patient's open mouth 54 between the upper lip 34 and the lower lip 36. The upper lip 34 and lower lip 36 are then placed into upper lip guard groove 42 and lower lip guard groove 44 respectively, which displaces the upper lip 34 and lower lip 36 out of the way of the dental professional's view of the patient's teeth 32 and maintains them in an comfortable, offset position. Alternatively, the dental professional may only need to work on one part of the mouth 54 and may only need to displace one of the upper lip 34 or lower lip 36, which the present invention allows.

FIG. 2 provides a cross-sectional view of a patient's mouth 54 while the lip protector 10 is in use. The intraoral mouthpiece 20, in combination with the lip protector 10, allows the dental professional to perform dental procedures without having to worry about the patient's facial and oral features getting in the way. For example, the tongue retractor 30 keeps the patient's tongue 40 out of the way by blocking the tongue 40 from its natural resting position and wrapping around the patient's back teeth 32. The upper lip guard 12 and lower lip guard 14 work in combination with the intraoral mouthpiece 20 to keep the patient's features out of the way. The perimeter 16 can be placed outside the patient's mouth 54 to protect the cheeks 38 or placed inside the cheeks 38 to protect the flesh inside the mouth 54, depending on the procedure being performed and/or the dental professional's or patient's preference.

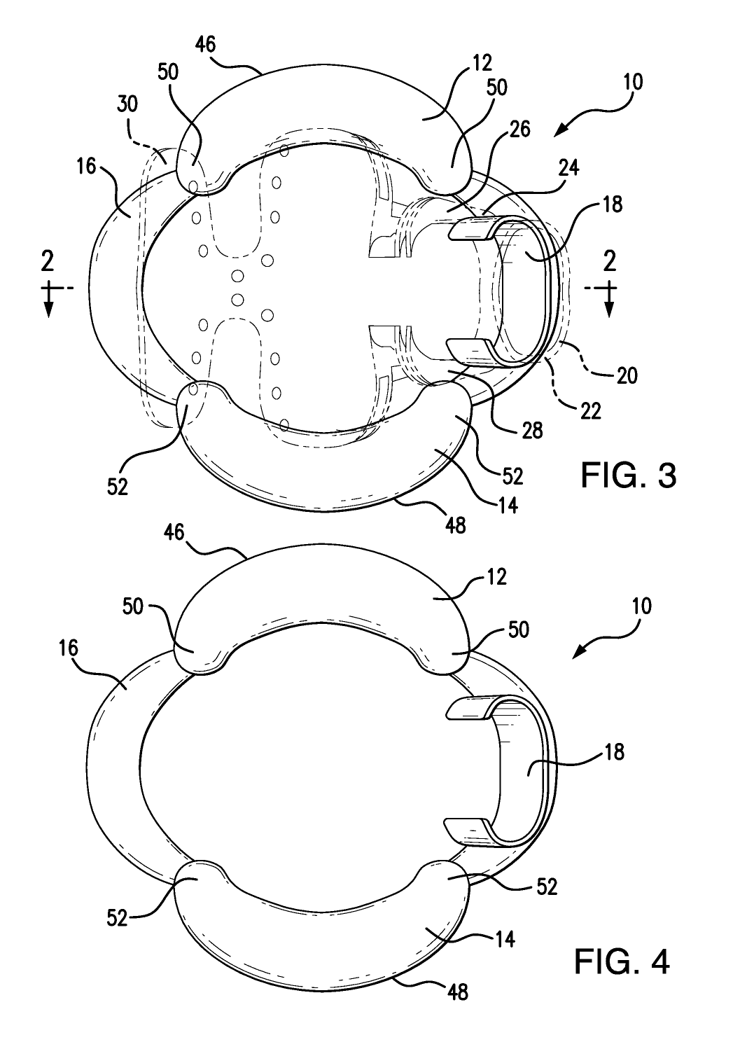

FIG. 3 shows the lip protector 10 with the intraoral mouthpiece 20 and FIG. 4 shows the lip protector 10 on its own. Preferably, the lip protector 10 is a single continuous piece of material. As can be seen in the figures, the upper lip guard 12 and the lower lip guard 14 are generally wider than the perimeter 16. This is because the upper lip guard 12 and the lower lip guard 14 need to house the patient's upper lip 34 and lower lip 36. Preferably the entire lip protector 10 is made of the same material which is generally pliable/malleable and bio-compatible. Materials can include silicon-based products and other plastics. It is preferable that the upper lip guard 12 and lower lip guard 14 be slightly stiffer than the perimeter 16. The diameter of the lip protector 10 is preferably such that the patient is comfortable and such that the dental professional can comfortably work. The lip protector 10 is reversible in that it can be rotated 180 degrees so that the dental professional can work on both sides of the patient's mouth 54 without having to have different left side/right side devices.

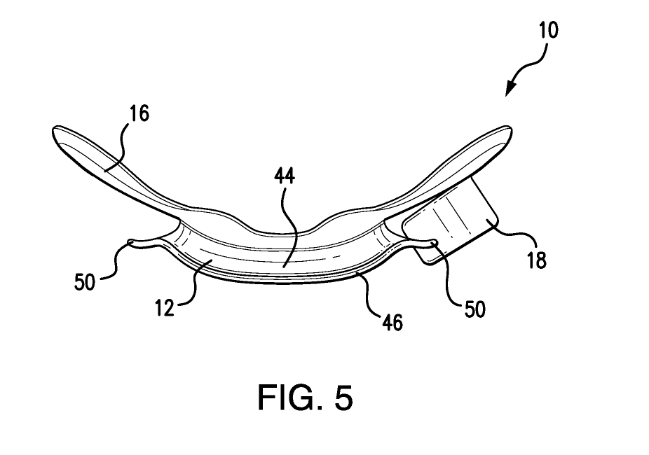

As can be seen in FIG. 5, the upper lip guard 12 and lower lip guard 14 are flared away from the patient's facial features such that if the dental professional is using a water pick or some other tool that could cause splashing the patient is protected. The patient's upper lip 34 fits into the upper lip guard groove 42 and the patient's lower lip fits into the lower lip guard groove 44. The upper lip guard 12 has a upper lip guard rim 46, which defines the outer edge of the upper lip guard 12. Similarly, the lower lip guard 14 (not shown in FIG. 5) has a lower lip guard rim 48, which defines the outer edge of the lower lip guard 14. The upper lip guard 12 also has flared upper lip guard ends 50 just as the lower lip guard 14 has flared lower lip guard ends 52. The upper lip guard ends 50 and the lower lip guard ends 52 are flared at a different angle from the rest of the upper lip guard rim 46 and lower lip guard rim 48 for the patient's comfort. The perimeter 16 can either be planar (not pictured) or flared inwardly, as shown in FIG. 5. This allows for the lip protector 10 to rest comfortably against the patient's face for the duration of the procedure.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts and methods may be resorted to without departing from the spirit and scope of the invention.

What is claimed is:

1. A lip protector made of a pliable, bio-compatible material for holding a patient's lips out of the way during a dental procedure, the lip protector comprising:
an upper and lower lip guard, each lip guard flared away from facial features, each lip guard comprising
a lip guard groove for receiving the dental patient's lip;
a lip guard rim; and
a flared lip guard end, wherein the upper and lower flared lip guard ends are each flared in substantially the same direction;
a substantially annular perimeter wherein the substantially annular perimeter connects the upper lip guard and the lower lip guard so that, when placed in the dental patient's mouth, the upper lip guard receives the patient's upper lip and the lower lip guard receives the patient's lower lip;
an intraoral mouthpiece comprising:
a tube;
a tongue retractor capable of maneuvering and holding the dental patient's tongue out of the way during the dental procedure; and
a bite guard comprising upper and lower bite grooves; and
a tube clip interconnected with the substantially annular perimeter such that the tube clip does not interfere with the upper and lower lip guards, the tube clip configured to receive the intraoral mouthpiece.

2. A lip protector comprising:
an upper and lower lip guard each having a groove connected by a perimeter; and
a tube clip attached to the perimeter.

3. The lip protector of claim 2 wherein the upper lip guard further comprises an upper lip guard groove, an upper lip guard rim, and a pair of flared upper lip guard ends.

4. The lip protector of claim 2 wherein the lower lip guard further comprises a lower lip guard groove, a lower lip guard rim, and a pair of flared lower lip guard ends.

5. The lip protector of claim 2 wherein both the upper lip guard and lower lip guard further comprise an upper and lower lip guard groove respectively.

6. The lip protector of claim 2 wherein the tube clip attaches the lip protector to a mouthpiece.

7. The lip protector of claim 6 wherein the mouthpiece further comprises a tube, a tongue retractor capable of maneuvering around a tongue and a tooth, and a bite guard comprising upper and lower bite grooves.

8. The lip protector of claim 2 wherein the upper lip guard is flared away from any facial features.

9. The lip protector of claim 2 wherein the lower lip guard is flared away from any facial features.

10. The lip protector of claim 2 wherein both the upper and the lower lip guard are flared away from any facial features.

11. The lip protector of claim 2 wherein the lip protector is made of a pliable, bio-compatible material.

12. A method for protecting lips during dental work comprising:
attaching a lip protector comprising an upper lip guard and a lower lip guard connected by a perimeter and further comprising a tube clip attached to the perimeter to a dental device;
placing the lip protector and dental device inside a patient's mouth;
placing a patient's upper lip inside a patient's upper lip guard forcing the upper lip to stay in an offset position exposing teeth; and
placing a patient's lower lip inside the lower lip guard forcing a patient's lower lip to stay in an offset position exposing teeth.

13. The method of claim 12 wherein the upper lip guard further comprises an upper lip guard groove, upper lip guard rim, and flared upper lip guard ends.

14. The method of claim 12 wherein the lower lip guard further comprises a lower lip guard groove, a lower lip guard rim, and a pair of flared lower lip guard ends.

15. The method of claim 12 wherein both the upper lip guard and lower lip guard further comprise an upper and lower lip guard groove respectively.

16. The method of claim 12 wherein the upper lip guard is flared away from facial features.

17. The method of claim 12 wherein the lower lip guard is flared away from any facial features.

18. The method of claim 12 wherein the upper and the lower lip guard are flared away from any facial features.

19. The method of claim 12 wherein the dental device comprises a tube, a tongue retractor capable of maneuvering around a tongue and a tooth, and a bite guard comprising upper and lower bite grooves.

20. The method of claim 12 wherein the lip protector is made of a pliable, bio-compatible material.
